(19) United States
(12) Patent Application Publication
(10) Pub. No.: US 2026/0362547 A1
(43) Pub. Date: Nov. 12, 2026

(54) ROUND ROBIN SHARING OF SCARCE NTN RESOURCES DURING EMERGENCIES

(71) Applicant: T-Mobile USA, Inc., Bellevue, WA (US)

(72) Inventor: Manoj Gupta, Bellevue, WA (US)

(21) Appl. No.: 19/201,622

(22) Filed: May 7, 2025

(51) Int. Cl. H04W 76/50; H04W 64/00; H04W 76/20; H04W 76/30; H04W 84/06

(52) U.S. Cl. CPC H04W 76/50; H04W 64/00; H04W 76/20; H04W 76/30; H04W 84/06

(57) ABSTRACT

Described herein are one or more computing devices that configure non-terrestrial network(s) (NTN(s)) to enable round robin sharing of NTN resources among user equipments (UEs) during an emergency situation. The computing device(s) determine a plurality of UEs at a location during the emergency situation and determine that the NTN resources available at the location are insufficient to support all UEs having a connection at a same time. The computing device(s) then configure the NTN(s) associated with the NTN resources to forcefully release UE connections or drop UE connections based an inactivity timer, thus enabling the round robin sharing of the NTN resources among the UEs.

### BACKGROUND

Cellular connectivity has largely been achieved by building earthbound access networks, such as cell towers, cellular antennae, etc., where people are located. A city may have extensive access network infrastructure, while a rural area may have less developed support. This can cause issues when populations suddenly shift, as sometimes happens during emergency situations. A large metropolitan area may be evacuated and its residents sent to a shelter in a rural area. Such a shelter may lack cellular infrastructure or may be far more limited in its support than the need presented.

Non-terrestrial networks (NTNs), including satellite-provided access networks, can extend coverage beyond where it is statically located. As more NTNs become available, NTN resources can provide some level of additional coverage during emergencies.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram showing user equipments (UEs) at a lower coverage location, such as a shelter, during an emergency situation engaging in round robin sharing of non-terrestrial network (NTN) resources, enabling each UE to have some connectivity and, e.g., send a text message.

FIG. 2 is a network architecture diagram of UEs, NTNs, a core network connecting to the access networks provided by the NTNs, and one or more computing device(s) determining the shortfall of NTN resources and configuring the NTN(s) to enable round robin sharing.

FIG. 3 is a flow diagram of an illustrative process for determining that the NTN resources available at a location are insufficient to support all UEs at the location having a connection at a same time and for configuring NTN(s) associated with the NTN resources to forcefully release UE connections or drop UE connections based on an inactivity timer to enable round robin sharing of the NTN resources among the UEs.

FIG. 4 is a schematic diagram of a computing device capable of implementing functionality of at least one of the systems described herein.

### DETAILED DESCRIPTION

This disclosure is directed in part to configuring non-terrestrial network(s) (NTN(s)) to enable round robin sharing of NTN resources among user equipments (UEs) during an emergency situation. Computing device(s) determine a plurality of UEs at a location during the emergency situation and determine that the NTN resources available at the location are insufficient to support the plurality of the UEs having a connection at a same time. The computing device(s) then configure the NTN(s) associated with the NTN resources to enable the round robin sharing of the NTN resources among the UEs by forcefully releasing the UE connections or by dropping UE connections based on an inactivity timer.

As used herein, “round robin sharing” refers offering connectivity in turns to a plurality of UEs. While some enforcement mechanism can be involved-only allowing a second connection after each UE has been connected—no such mechanism is required for round robin sharing. Rather, the NTN providing the round robin sharing among the UEs may simply provide connections in no particular order and rely on the shortened connection period to ensure that the UEs are each having turns and sharing the NTN resources, and such sharing suffices for “round robin sharing” in this disclosure.

The round robin sharing may be based on logic or an inactivity timer that is part of the NTN(s) but may be configured or set by one or more other computing devices, such as those of a network operations center. A telecommunication network operator may operate the network operations center and a core network and may provide connectivity to UEs through the NTN(s) and terrestrial networks. The NTN(s) may be operated by the telecommunication network operator or by another entity in an arrangement with the telecommunication network operator to provide access network services by, e.g., satellite.

The inactivity timer may be an RRC inactivity timer and may be statically set based on, e.g., a duration of time taken to send a text message, or on a very short duration, such as one second or less, or dynamically set based on artificial intelligence (AI) and/or machine learning (ML). When the timer expires, rather than simply moving the UE associated with the timer to an idle state, the NTN connected to that UE drops the connection, freeing up NTN resources of that NTN for another of the UEs. Alternatively or additionally, the NTN may have logic that forcefully releases the UE connection after some event (e.g., sending a text), after a time period, etc. Such forceful releasing does not require the NTN to wait for a period of inactivity, as use of the inactivity timer does.

In some implementations, a second timer, such as an RRC reestablishment timer at the NTN(s) or core network, may be lengthened, causing the connection information for a disconnected UE to be held longer such that, when the UE reconnects to an NTN, the connection across the core network for that UE may not need to be reestablished. As a result, the timers herein are shortened for connection legs over scarce resources (e.g., NTN resources) and lengthened for connection legs where resources are not scarce, reducing excess signaling that could otherwise result.

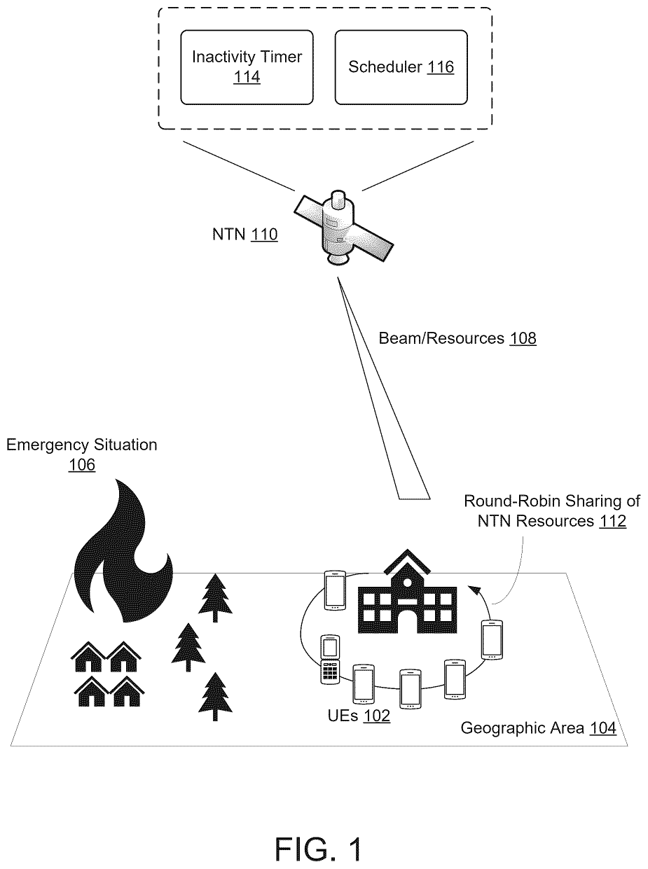

FIG. 1 is an overview diagram showing UEs at a lower coverage location, such as a shelter, during an emergency situation engaging in round robin sharing of NTN resources, enabling each UE to have some connectivity and, e.g., send a text message. As illustrated, UEs 102 may be located in a geographic area 104 experiencing an emergency situation 106. In response to the emergency situation 106, the users and their UEs 102 may relocate to a safer location, such as a shelter. The shelter may be underprovisioned with wireless resources (e.g., base stations, other access points, etc.). While NTN resources, such as beam 108 of an NTN 110 may be available at the location of the UEs 102, those resources may be insufficient to support connectivity to the UEs 102 at a same time. To address this situation, the NTN 110 may enable round robin sharing 112 among the UEs 102 of the connectivity offered by the beam 108. The NTN may achieve this by, e.g., forcefully releasing the UE connection or using an inactivity timer 114 to drop UEs 102 from their NTN connections after a brief time period. Further, the NTN 110 may have a scheduler 116 to accept and drop connections with the UEs 102.

In various implementations, emergency situations 106, such as earthquakes, tsunamis, hurricanes, tornados, forest fires, etc. may all result in evacuations and consequent movement of users and their UEs 102 to locations that not be known in advance by those users or by providers of telecommunications services. Consequently, access networks, such as fixed location terrestrial networks (e.g., cell towers) and NTNs may not be located where users are being sent-e.g., a shelter. Even if some of them are located at that location, they may not provide sufficient coverage for the users converging there. Further, the need for connectivity may be even greater during an emergency situation 106 than during normal circumstances. Users may need to tell friends and family their status (i.e., that they are okay) and where they are. Even the need for diversion (e.g., browsing the web, watching streaming videos, etc.) may be felt more keenly in emergencies. Thus users in FIG. 1 find themselves at a location with their UEs 102 but without sufficient wireless resources during an emergency situation 106.

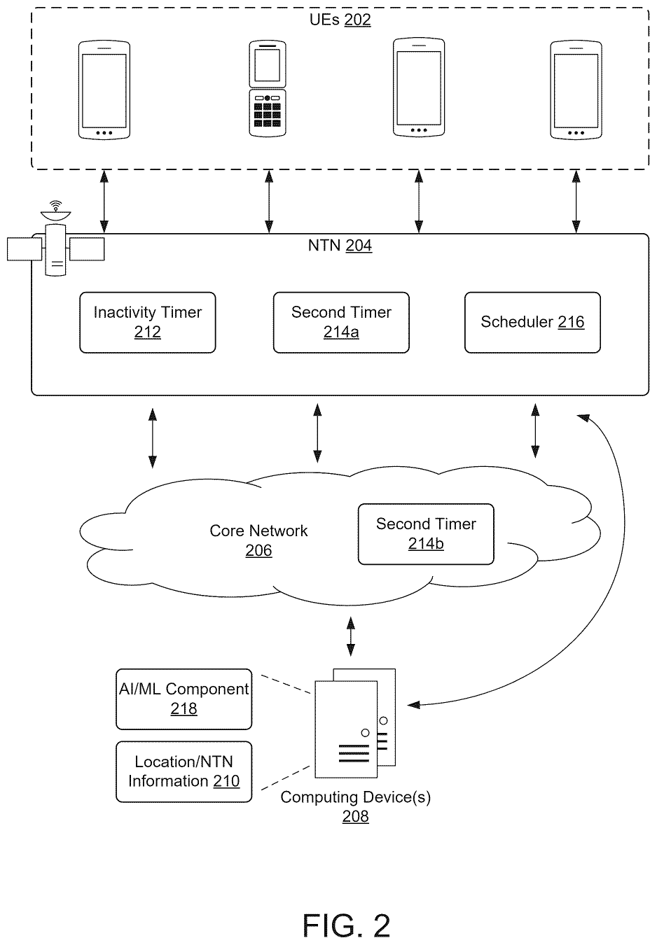

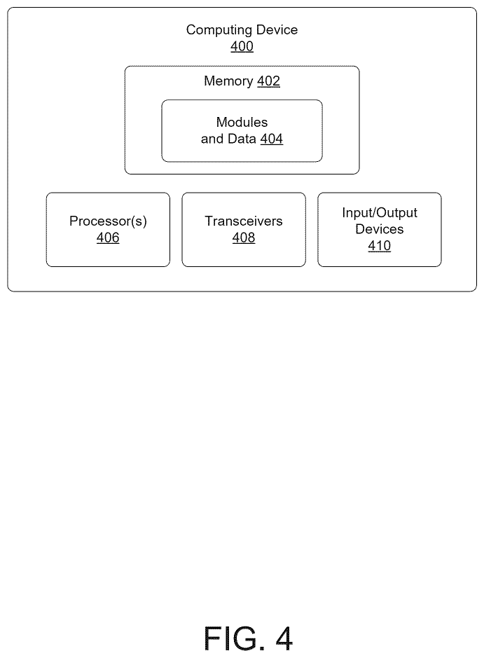

While users are involved in relocating and trying to connect to their telecommunications providers, those providers may be taking measures to ensure greater resources for the UEs 102 of the users at the location that the users are going to. Achieving this may first involve one or more computing devices of the telecommunication provider determining that an emergency situation 106 in a geographic area 104 is ongoing. These computing device(s) (not pictured in FIG. 1) may be any sort of computer systems, including personal computers (PCs), laptop computers, tablet computers, cellular devices, server computers, mainframe computers, etc. The computing device(s) may also include virtual machines operating on physical computing devices. Additionally, the computing device(s) may be located on a single network or spread across multiple networks and may have a single network operator or by device(s) of multiple network operators working together. Example computing device(s) are shown in FIGS. 2 and 4 and described with reference to those figures in greater detail herein.

Such a determination that an emergency situation 106 in a geographic area 104 is ongoing may be achieved or received in any number of ways; the provider may receive an alert from a public service entity charged with notifying people in a geographic area of the emergency situation that the provider is obligated to message out to the UEs 102 that are connected to it. The computing device(s) of the provider may then monitor locations of UEs 102 to determine if any locations in the geographic area 104 or near the geographic area 104 seem to be points of convergence. Additionally or alternatively, the provider may be notified via social media or alerts of a shelter location. The computing device(s) may then determine whether the resources at the location of convergence/shelter are sufficient for the UEs 102 projected to be there to have a connection at the same time. When those resources are not sufficient, the computing device(s) may identify the NTNs serving the location, such as NTN 110, to configure them for round robin sharing 112. Alternatively, when an emergency occurs, the telecommunications provider may configure all NTNs serving the geographic area 104 for round robin sharing, without need to identify a shelter or location where users are converging.

In various implementations, the NTNs, including NTN 110, may be satellites, such as low earth orbital satellites that provide connectivity through beams, such as beam 108. It is these beams that are referred to herein as NTN resources. In some implementations, the NTNs may be operated by a different entity than the entity associated with the telecommunications provider. When multiple entities are involved, instructions may be communicated as requests or as directions depending on the relationship between the entities and the technical equipment used to effectuate transmission of instructions to NTNs.

As shown in FIG. 1, the NTN 110 may have an inactivity timer 114, and the inactivity timer 114 that may be configured by computing device(s) of the telecommunications provider to effectuate the round robin sharing 112. The inactivity timer 114 may be an RRC inactivity timer set to change from an RRC connected state to an RRC idle state for a connection with a UE 102 following a time period of inactivity. In addition to setting the time period of the inactivity timer 114, or alternatively, the computing device(s) may update logic of the NTN 110, such as the scheduler 116, to forcefully release the UE connection following an event or a separate timer.

In some implementations, the UEs 102 attempting to connect to the NTN 110 may be any sort of wireless communication devices, such as cellular phones, tablet computers, Internet-of-Things (IoT) devices (e.g., a watch, glasses, goggles, etc.), gaming devices, etc. Their users may subscribe for services of an operator of a telecommunications network that operates or is associated with an operator of the NTN 110 and may use their UEs 102 to access those services.

For the sake of illustration, please assume one NTN 110 is available at the location of the UEs 102, and that only a single UE 102 may be connected via the beam 108 at a given time. In other examples, any number of NTNs may be available at the location of the UEs 102, a given NTN may have multiple beams 108, and multiple UEs 102 may be connected via a single beam 108. In the example given for the sake of illustration, though, multiple ones of the UEs 102 may attempt to connect via the beam 108 to the NTN 110, and the scheduler 116 of the NTN 110 may select one of these UEs 102 and connect to it. With the connection established, the user of the connected UE 102 may engage in activities such as sending a text message, making a call, etc. But as the UE 102 will be round robin sharing 112 with other UEs 102, there may only be time for, e.g., a complete text message transmission before the connection of the UE 102 is dropped or forcefully released by the NTN 110. In some implementations, the NTN 110 may transmit a message to the UE 102 to alert the UE 102 of the short connection duration so that its user selects an appropriate activity. Once the inactivity timer 114 is triggered by inactivity and expires, the NTN 110 may drop the connection with that UE 102. Additionally or alternatively, following an event or other time period, the NTN 110 may forcefully release the connection with the UE 102, even if there has been no inactivity.

Continuing with the example, different ones of the UEs 102 may then have their connection requests accepted by the NTN 110, again with the shortened connection duration. In some implementations, the NTN 110 may simply continue to take the first UE 102 to have its request received and rely on the frequency of switching among the UEs 102 to give every UE a chance. In other implementations, the scheduler 116 may track an identifier of the most recently connected UE 102 and accept connection requests only from others of the UEs 102. In yet other implementations, the scheduler 116 may track identifiers of each UE 102 that a request is received from and whether a request was granted, ensuring that no UE 102 is granted a second connection request until each is granted one request. Round robin sharing 112 among the UEs 102 may be achieved in any of these ways. In some examples, after each UE 102 is connected or after a period of time, the NTN 110 may terminate round robin sharing 112.

In various implementations, the computing device(s) of the telecommunications provider may set the inactivity timer 114 of the NTN 110 either statically or dynamically. If statically, the time period chosen for the inactivity timer 114 may reflect, e.g., the time taken to transmit a text message, a very brief time period (e.g., one second), etc. If dynamic, the telecommunications provider may used artificial intelligence (AI) or machine learning (ML) to evaluate whether the time period is long enough, e.g., for messages to be sent. For example, if none of the round robin connections are resulting in a message being sent, the telecommunications provider may increase the time period to allow messages to be sent. Such measures—e.g., messages sent—may be tracked by the AI/ML and result in updated configurations to the inactivity timer 114 or to the logic handling the forceful releasing of UE connections.

In further implementations, to avoid needing to set up connections across its core network more frequently, the telecommunications provider may lengthen a second timer, such as an RRC reestablishment timer. That second timer may provide a period of time in which the data connection for a UE 102 across the core network is maintained. By lengthening the timer, the telecommunications provider increases the chance that a given UE 102 will have a second connection with the NTN 110 before the data connection across the core network is released. This is turn avoids the signaling needed to establish a new data connection across the core network.

FIG. 2 is a network architecture diagram of UEs, NTNs, a core network connecting to the access networks provided by the NTNs, and one or more computing device(s) determining the shortfall of NTN resources and configuring the NTN(s) to enable round robin sharing. As illustrated, UEs 202 communicate wirelessly with NTN 204 and, through the NTN 204, to one or more nodes of the core network 206. The core network 206 may in turn include or be connected to computing device(s) 208, which may be part of a network operations center of the telecommunications provider associated with core network 206. The computing device(s) 208 may include location/NTN information 210 used to determine when to configure the inactivity timer 212 of the NTN 204. The computing device(s) 208 may also configure a second timer 214a, located in the NTN 204, or a second timer 214b, located in the core network 206. The NTN 205 may also have a scheduler, and the computing device(s) 208 may have AI/ML component 218 to dynamically determine, e.g., the time period for the inactivity timer 212.

The UEs 202 may be examples of the UEs 102 and the NTN 204 may be an example of the NTN 110. Also, the inactivity timer 212 may be an example of the inactivity timer 114 and the scheduler 216 may be an example of the scheduler 116. The computing device(s) 208 may be an example of the computing device(s) of the telecommunication provider discussed with reference to FIG. 1. The core network 206 may be any sort of core network, such as an evolved packet core (EPC), a Fifth Generation (5G) core network, a Sixth Generation (6G) core network, etc. and it may include or be associated with an Internet multimedia subsystem (IMS).

As shown in FIG. 2, the second timer 214 may be located in the NTN 204, as second timer 214a, or may be located in the core network as second timer 214b. In either case, the use of the second timer 214 may be the same as the second timer discussed with reference to FIG. 1: to preserve the data connections across the core network. The second timer 214 may thus be a RRC reestablishment timer or other timer with a similar purpose.

Additionally, the computing device(s) 208 may communicate with the NTN 204 through the core network 206 or independently of it in differing implementations. The configurations of the inactivity timer 212 or logic for forcefully releasing UE connections may be by requests transmitted to the NTN 204 or to a management entity associated with the NTN 204. Alternatively, the scheduler 216 may act as a client of the computing device(s) 208, which may provide the time period and/or logic to the NTN 203 in a client-server manner.

The location/NTN information 210 may comprise indications of whether an emergency situation is ongoing, locations of the UEs 202, a location and trajectory of the NTN 204, etc. Such information may be used by the computing device(s) 208 to determine that there are insufficient NTN resources at a location with UEs 202 and that an emergency is ongoing. Further, this location/NTN information 210 may inform the computing device(s) when one or both factors (insufficient NTN resources and emergency situation) is no longer ongoing, causing the computing device(s) 208 to revert the configurations of the NTN 204 to their typical values.

The AI/ML component 218 may dynamically determine a length of the time period of the inactivity timer 212 as described further herein with respect to use of AI/ML.

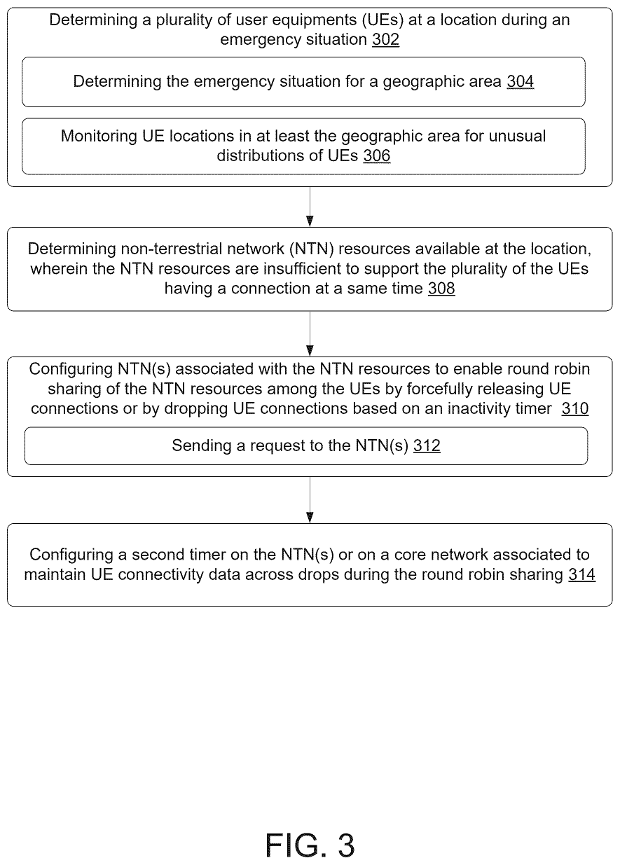

FIG. 3 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for determining that the NTN resources available at a location are insufficient to support all UEs at the location having a connection at a same time and for configuring NTN(s) associated with the NTN resources to forcefully release UE connections or drop UE connections based on an inactivity timer to enable round robin sharing of the NTN resources among the UEs.

As illustrated at 302, one or more computing devices determine a plurality of UEs at a location during an emergency situation. The determining may include determining, at 304, the emergency situation for a geographic area and monitoring, at 306, UE locations in at least the geographic area for unusual distributions of UEs. In some implementations, the unusual distribution of UEs may signify a shelter location. Additionally, there may be no TNs at the location or, if there are, the resources offered by the TNs, when added to the NTN resources, may be insufficient to support the plurality of the UEs having a connection at a same time.

At 308, the one or more computing devices determine NTN resources available at the location, and the NTN resources are insufficient to support the plurality of the UEs having a connection at a same time.

At 310, the one or more computing devices configure NTN(s) associated with the NTN resources to enable round robin sharing of the NTN resources among the UEs by forcefully releasing UE connections or by dropping UE connections based on an inactivity timer. At 312, the inactivity timer may be located at the NTN(s) and the configuring may comprise sending a request to the NTN(s). In some implementations, the inactivity timer may be an RRC inactivity timer set to change from an RRC connected state to an RRC idle state following a time period of inactivity, and the NTN(s) may drop the UE connections when the RRC inactivity timer changes to the RRC idle state. Also, the time period may be configured based on, e.g., a time period for transmitting a text message, or a short time period such as one second. Further, the time period for the timer may be set based on machine learning or artificial intelligence.

At 314, the inactivity timer may be a first timer, and the one or more computing devices may further configure a second timer on the NTN(s) or on a core network to maintain UE connectivity data across drops during the round robin sharing. In some implementations, the second timer may be an RRC reestablishment timer.

FIG. 4 is a schematic diagram of a computing device capable of implementing functionality of at least one of the systems described herein. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the devices and components described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and NTN communications. Thus, the scope of the disclosure is not limited to the examples described herein.

What is claimed is:

1. A method comprising:
determining, by one or more computing devices, a plurality of user equipments (UEs) at a location during an emergency situation;
determining, by the one or more computing devices, non-terrestrial network (NTN) resources available at the location, wherein the NTN resources are insufficient to support the plurality of the UEs having a connection at a same time; and
configuring, by the one or more computing devices, NTN(s) associated with the NTN resources to enable round robin sharing of the NTN resources among the UEs by forcefully releasing UE connections or dropping the UE connections based on an inactivity timer.

2. The method of claim 1, wherein the determining the plurality of UEs at the location comprises determining the emergency situation for a geographic area and monitoring UE locations in at least the geographic area for unusual distributions of UEs.

3. The method of claim 2, wherein the unusual distribution of UEs signifies a shelter location.

4. The method of claim 1, wherein:
there are no terrestrial networks (TNs) at the location, or
there are TNs at the location, but resources offered by the TNs, when added to the NTN resources, are insufficient to support the plurality of the UEs having a connection at a same time.

5. The method of claim 1, wherein the inactivity timer is a first timer, and the method further comprises configuring a second timer on the NTN(s) or on a core network to maintain UE connectivity data across drops during the round robin sharing.

6. The method of claim 5, wherein the second timer is a radio resource control (RRC) reestablishment timer.

7. The method of claim 1, wherein the inactivity timer is a radio resource control (RRC) inactivity timer set to change from an RRC connected state to an RRC idle state following a time period, and the NTN(s) drop the UE connections when the RRC inactivity timer changes to the RRC idle state.

8. The method of claim 7, wherein the time period is configured based on a time period for transmitting a text message.

9. The method of claim 7, wherein a time period for the timer is set based on machine learning or artificial intelligence.

10. The method of claim 1, wherein the inactivity timer is located at the NTN(s) and the configuring comprises sending a request to the NTN(s).

11. A system comprising:
one or more processors; and
programming instructions that, when executed by the one or more processors, cause the system to perform operations including:
determining a plurality of user equipments (UEs) at a location during an emergency situation;
determining non-terrestrial network (NTN) resources available at the location, wherein the NTN resources are insufficient to support the plurality of the UEs having a connection at a same time; and
configuring NTN(s) associated with the NTN resources to enable round robin sharing of the NTN resources among the UEs by forcefully releasing UE connections or by dropping UE connections based on an inactivity timer.

12. The system of claim 11, wherein the determining the plurality of UEs at the location comprises determining the emergency situation for a geographic area and monitoring UE locations in at least the geographic area for unusual distributions of UEs.

13. The system of claim 11, wherein:
there are no terrestrial networks (TNs) at the location, or
there are TNs at the location, but resources offered by the TNs, when added to the NTN resources, are insufficient to support the plurality of the UEs having a connection at a same time.

14. The system of claim 11, wherein the inactivity timer is a first timer, and the operations further comprise configuring a second timer on the NTN(s) or on a core network to maintain UE connectivity data across drops during the round robin sharing.

15. The system of claim 11, wherein the inactivity timer is a radio resource control (RRC) inactivity timer set to change from an RRC connected state to an RRC idle state following a time period, and the NTN(s) drop the UE connections when the RRC inactivity timer changes to the RRC idle state.

16. The system of claim 11, wherein the inactivity timer is located at the NTN(s) and the configuring comprises sending a request to the NTN(s).

17. A non-transitory computer storage medium having programming instructions stored thereon that, when executed by one or more processors of one or more computing devices, cause the one or more computing devices to perform operations comprising:
determining a plurality of user equipments (UEs) at a location during an emergency situation;
determining non-terrestrial network (NTN) resources available at the location, wherein the NTN resources are insufficient to support the plurality of UEs having a connection at a same time; and
configuring NTN(s) associated with the NTN resources to enable round robin sharing of the NTN resources among the UEs by forcefully releasing UE connections or by dropping UE connections based on an inactivity timer.

18. The non-transitory computer storage medium of claim 17, wherein the inactivity timer is a first timer, and the operations further comprise configuring a second timer on the NTN(s) or on a core network to maintain UE connectivity data across drops during the round robin sharing.

19. The non-transitory computer storage medium of claim 17, wherein the inactivity timer is a radio resource control (RRC) inactivity timer set to change from an RRC connected state to an RRC idle state following a time period, and the NTN(s) drop the UE connections when the RRC inactivity timer changes to the RRC idle state.

20. The non-transitory computer storage medium of claim 17, wherein the inactivity timer is located at the NTN(s) and the configuring comprises sending a request to the NTN(s).
